(19) United States
(12) Patent Application Publication
(10) Pub. No.: US 2023/0147410 A1
(43) Pub. Date: May 11, 2023

(54) RELATING TO ACCESS TO SERVICES AFTER A DISASTER CONDITION

(71) Applicant: Samsung Electronics co., Ltd., Gyeonggi-do (KR)

(72) Inventors: Mahmoud Watfa, Middlesex (GB); Lalith Kumar, Bangalore (IN)

(21) Appl. No.: 17/984,634

(22) Filed: Nov. 10, 2022

(30) Foreign Application Priority Data
Nov. 10, 2021 (IN) 202131051487
Nov. 9, 2022 (GB) 2216653.2

(51) Int. Cl. H04W 24/04; H04W 8/02

(52) U.S. Cl. CPC H04W 24/04; H04W 8/02

(57) ABSTRACT

The disclosure relates to a 5G or 6G communication system for supporting a higher data transmission rate, A method and apparatus are provided for providing updated details to a user equipment (UE) that is disaster roaming in a second telecommunications network due to a disaster condition affecting an area of a first telecommunication network. The second telecommunication network determines that the area has changed and sends updated details to the UE. The updated details relates to the changed area affected by the disaster condition.

### CROSS-REFERENCE TO RELATED APPLICATION(S)

This application is based on and claims priority under 35 U.S.C. § 119(a) to Indian Patent Application No. 202131051487, which was filed in the Indian Intellectual Property Office on Nov. 10, 2021, and to U.K. Patent Application No. 2216653.2, which was filed in the U.K. Intellectual Property Office on Nov. 9, 2022, the entire disclosure of each of which is incorporated herein by reference.

### BACKGROUND

### 1. Field

The disclosure relates generally to improvements in providing disaster roaming service, and more particularly, to minimization of service interruption (MINT).

### 2. Description of Related Art

5^{th} generation (5G) mobile communication technologies define broad frequency bands such that high transmission rates and new services are possible, and can be implemented not only in “sub 6 GHz” bands such as 3.5 GHz, but also in “above 6 GHz” bands referred to as mmWave including 28 GHz and 39 GHz. In addition, it has been considered to implement 6^{th} generation (6G) mobile communication technologies (referred to as beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting mufti-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

Disaster roaming is a service in which a UE registered with a first network (i.e., a home network) is permitted to temporarily roam on a second network in the event that the first network is afflicted by some form of outage, such as fire, earthquake, or other disaster.

3^{th} generation partnership project (3GPP) working groups have developed solutions for a UE to get service even when a disaster condition occurs on a public land mobile network (PLMN). That is, the UE may obtain disaster roaming service on a forbidden PLMN when no other PLMN is available.

Information on disaster roaming services can be found in 3GPP TR 24.811, whereas normative specification for the related work has been specified in 3GPP TS 23.122, 23.501, and 24.501.

After the disaster ends, the UE is expected to return to its previous PLMN as quickly as possible. As such, the PLMN that provides disaster roaming service will ensure the UE returns back to its original PLMN, which has recovered from the disaster condition.

A problem encountered in the conventional methods, however, is that the disaster roaming services area may change during a UE's registration. The disaster roaming service may be provided over an area that overlaps with the area of the disaster area. For example, if PLMN D experiences a disaster in an area (e.g., area X), then the UE gets services on PLMN A, which offers disaster roaming service, such that the area of service in PLMN A would overlap with area X. For example, when the UE registers with PLMN A for disaster roaming service, an access and mobility management function (AMF) will provide a registration area (RA) with tracking area identities (TAI) #1 and TAI #2, assuming that these TAIs correspond to area X, noting that the determination of this overlap area is based on implementation methods and hence not specified in the relevant standard. In other words, different network operators may determine this overlap area in different ways.

However, it is possible that the area of the disaster may change, e.g., if the disaster is a fire, the fire may extend to other areas. Consequently, the disaster area may get bigger and spread beyond original area A. Hence, the UE that is registered for disaster roaming service for which the RA is TAI #1 and TAI #2 will not correspond to the new area. As such, a method is required to provide a new area to a UE.

Similarly, it is possible that the fire is extinguished in one sub-area of Area A and, as such, the disaster condition area may now be smaller, e.g. Area B, where Area B is a smaller area (or a sub-set) of area A. Again, this may mean that the UE's RA may need to be changed, e.g., to only include TAI #2 or another area.

Accordingly, a conventional disaster roaming service may be insufficient as it does not update the TAI of the UE due to a change in the disaster condition area. While a network at any time can update a UE's RA, currently there is no trigger to do so based on a change in the disaster condition area.

A further problem is related to how to send certain information elements (IEs) and the conditions under which to do so.

Document C1-216938 (PLMN with disaster condition, 3GPP TSG-CT WG1 Meeting #133-e, 11-19 Nov. 2021) proposes that a UE can send a new IE referred to as a “PLMN with disaster condition IE”, in which the UE indicates the PLMN with disaster condition, i.e., the UE indicates the PLMN that the UE is either coming from, or the PLMN that the UE intending to register with, but that has now experienced a disaster condition.

Specifically, Document C1-216938 provides the following regarding when the UE should send this IE to the network:
If the UE initiates the registration procedure for disaster roaming services and:
the PLMN with disaster condition is the HPLMN and the 5GS mobile identity IE contains neither the SUCI nor a valid 5G-GUTI that was previously assigned by the HPLMN; or
the PLMN with disaster condition is not the HPLMN and the 5GS mobile identity IE does not contain a valid 5G-GUTI that was previously assigned by the PLMN with disaster condition;
then the UE shall include in the REGISTRATION REQUEST message the PLMN with disaster condition IE indicating the PLMN with disaster condition.

The following, from Document C1-216938, describes how the AMF determines that the PLMN is experiencing a disaster condition:
If the 5GS registration type IE is set to “disaster roaming initial registration” and:
a) the PLMN with disaster condition IE is included in the REGISTRATION REQUEST message, the AMF shall determine the PLMN with disaster condition in the PLMN with disaster condition IE; or
b) the PLMN with disaster condition IE is not included in the REGISTRATION REQUEST message and:

1) the 5GS mobile identity IE contains 5G-GUTI, Global Unique Temporary Identifier, the AMF shall determine the PLMN with disaster condition in the PLMN identity of the 5G-GUTI; or

2) the 5GS mobile identity IE contains SUCI, Subscription Concealed Identifier, the AMF shall determine the PLMN with disaster condition in the PLMN identity of the SUCI.

Given the above, the following further problems still exist.

The conditions under which to send the PLMN with disaster condition IE (or any other IE that may be defined for the purpose of sending a PLMN ID to identify the PLMN with a disaster condition) are unknown.

One of the conditions that is listed in Document C1-216938 for the UE to send the “PLMN with disaster condition” IE is that “the 5GS mobile identity IE does not contain a valid 5G-GUTI”. This is problematic, however, because there is at least one other case in which the UE does have a valid 5G-global unique temporary identifier (GUTI), but does not send it in a 5^{th} generation system (5GS) mobile identity IE and, instead, sends it in an additional GUTI IE, as explained below from TS24.501:
During initial registration the UE handles the 5GS mobile identity IE in the following order:
a) if;
1) the UE:
   i) was previously registered in S1 mode before entering state EMM-DEREGISTERED; and
   ii) has received an “interworking without N26 interface not supported” indication from the network; and
2) EPS security context and a valid 4G-GUTI are available;
then the UE shall create a 5G-GUTI mapped from the valid 4G-GUTI and indicate the mapped 5G-GUTI in the 5GS mobile identity IE. The UE shall include the UE status IE with the EMM registration status set to “UE is not in EMM-REGISTERED state” and shall include an ATTACH REQUEST message as specified in 3GPP TS 24.301 [15] in the EPS NAS message container IE.
Additionally, if the UE holds a valid 5G GUTI, the UE shall include the 5G-GUTI in the Additional GUTI IE in the REGISTRATION REQUEST message in the following order:
1) a valid 5G-GUTI that was previously assigned by the same PLMN with which the UE is performing the registration, if available;
2) a valid 5G-GUTI that was previously assigned by an equivalent PLMN, if available; and
3) a valid 5G-GUTI that was previously assigned by any other PLMN, if available.

As shown above, a UE may have a valid 5G-GUTI, but the 5G-GUTI will instead be sent in the Additional GUTI IE instead.

As such, the conditions proposed in Document C1-216938 are incorrect. Consequently, how the AMF determines the PLMN identity is incorrect, since the current proposal in Document C1-216938 requires the AMF to always use the 5G-GUTI, if present, in the 5GS mobile identity IE. However, as shown above, the valid 5G-GUTI may actually be in the Additional GUTI IE instead, and consequently, the AMF will use the wrong IE to determine the PLMN ID as per the proposal in Document C1-216938.

Further, it is not specified in the prior art whether to send the PLMN ID in a secure manner or not. It is currently not specified how to send the PLMN ID (e.g., the “PLMN with disaster condition” IE) to the network. In particular, it is not specified whether this information should be security protected or not. While sending the information without security protection can lead to some privacy issues where the UE's last serving PLMN may be known, if the UE sends the information in a protected manner, then there will be delays for the network (e.g., the AMF) to get this information, since the UE will only be able to send it after security is established and this may take a few rounds of non-access stratum (NAS) message exchanges. Consequently, a delay may lead to delayed rejection of the UE, if the AMF determines not to provide disaster roaming for the indicated PLMN. Hence, the overall service of the UE may be delayed.

As such, a need exists to specify how the information should be sent; otherwise, there may be cases in which different UEs will send the same information at different stages of the registration procedure and that can consequently lead to random outcomes and unnecessary signaling and delays.

A further problem is that other IEs are unnecessarily sent during registration by a UE that supports S1 mode.

More specifically, a UE capable of the S1 mode will include an evolved packet system (EPS) NAS message container IE, which can contain either an Attach Request or Tracking Area Update Request message, in a Registration Request message when registering with the AMF as described in TS 24.501. The AMF normally sends the EPS NAS message to a mobility management entity (MME), which verifies the integrity protection of the message in order to verify the authenticity of the UE, etc. However, disaster roaming services are not applicable to EPS and it is therefore unnecessary to send all this information, or use this information at the network, when it is already known that EPS is not involved in disaster roaming services. As such, a need also exists for a mechanism to avoid sending this information or to at least attempt to not use this information at the network side, since this will just add additional delays to the service.

### SUMMARY

The disclosure has been made to address the shortcomings set out above, as well as other shortcomings not necessarily referred to herein, and to provide at least the advantages described below.

An aspect of the disclosure is to provide an apparatus and method for providing updated details to a UE when the UE is disaster roaming.

In accordance with an aspect of the disclosure, a method is provided for providing updated details to a UE, when the UE is disaster roaming in a second telecommunications network due to a disaster condition affecting an area of a first telecommunication network. The second telecommunication network determines that the area has changed and sends updated details to the UE from the second telecommunication network. The updated details relate to the changed area affected by the disaster condition.

The area and the changed area may be defined in terms of an RA.

The RA may be defined in terms of one or more TAIs.

The changed area may be entirely separate from the original area, entirely contained within the original area, or overlapping with the original area.

An AMF of the second telecommunication network may determine the changed area.

The UE may be informed of the changed area via an NAS message.

The NAS message may include a Configuration Update Command message including one or more TAIs that best correspond to the changed area.

If the UE is not in connected state, then the second telecommunication network may first page the UE to get it into connected state.

If the second telecommunication network receives an NAS message from the UE, and the second telecommunication network may determine that the UE is not an area impacted by the disaster condition, and then reject the message from the UE.

The area from which the UE sent the NAS message was previously an area in which disaster roaming service may be provided and the second telecommunication network may reject the message due to the change in the area.

The AMF of the second telecommunication network may reject a message from the UE with a 5G mobility management (SGMM) cause code #11 or #13.

In accordance with another aspect of the disclosure, a method is provided for a UE to indicating, to a telecommunication network offering disaster roaming, the identity of a telecommunication network that has experienced a disaster condition. The method includes the UE indicating the identity of the telecommunication network that has experienced the disaster condition in cleartext.

The telecommunication network that has experienced the disaster condition may be the telecommunication network that the UE was coming from or which it intended to register with.

### BRIEF DESCRIPTION OF THE DRAWINGS

The above and other aspects, features and advantages of certain embodiments of the disclosure will be more apparent from the following detailed description taken in conjunction with the accompanying drawings, in which;

FIG. 1 illustrates an electronic device in a network environment, according to an embodiment; and

FIG. 2 is a flowchart illustrating a method according to an embodiment.

### DETAILED DESCRIPTION

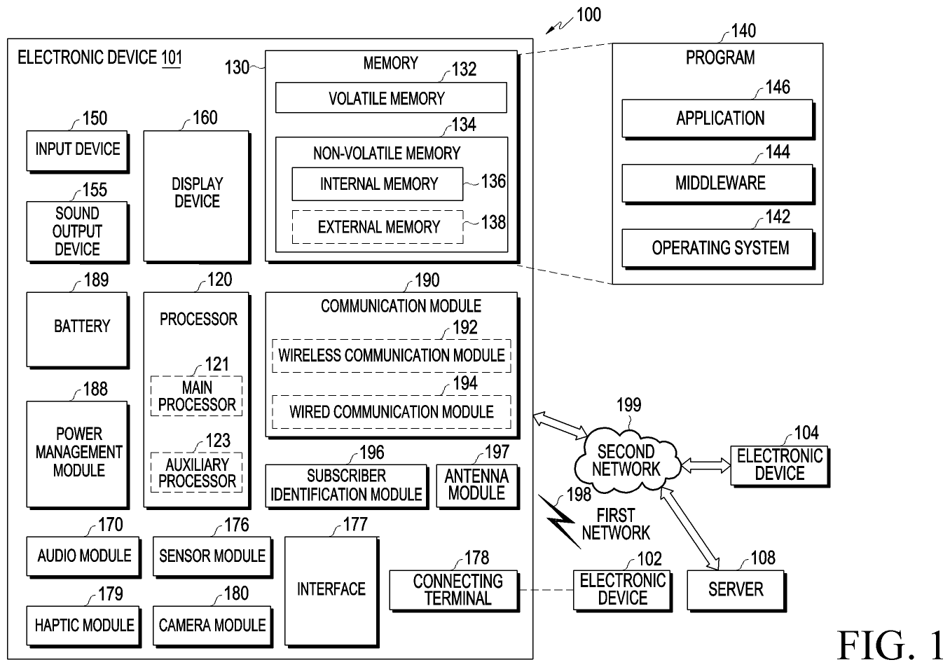

FIG. 1 illustrates an electronic device in a network environment according to an embodiment.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or he communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, e.g., an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

In accordance with an embodiment a UE's registration area may be updated based on changes in the area that is affected by the disaster condition.

More specifically, a UE may be registered for disaster roaming service. A network may be serving a UE that is registered for disaster roaming service, where the network may determine that the UE is registered for disaster roaming based on the UE's context in the network or based on the UE requesting a registration type that is related to disaster roaming service, or based on the network indicating to the UE that a UE is registered for disaster roaming (e,g., using the 5GS registration result field), or based on any other method or combination of methods including those listed above.

The network that is serving a UE that is registered for disaster roaming service may determine, based on any method (standardized or not), that the area of the disaster condition has changed. When this occurs, the AMF may act as described below in any order or combination:
The AMF determines that the area of disaster condition (related to the PLMN that has experienced disaster) has changed.
The AMF may then determine a new (or an updated) registration area (or service area) for a UE in question, optionally where the UE is related to (or associated with) the PLMN for which the area of disaster condition has changed.
   The new (or updated) registration area (or service area) may be larger or smaller than the current registration area of the UE,
After or upon determination of a change in the area in which a UE should be served (e.g., when the UE is registered for disaster roaming, and optionally where the current registration area of the UE is not correctly overlapping with the new/updated disaster area), the AMF may send the Configuration Update Command message (or any other NAS message) to the UE and include the TAI list IE (or TAI list) where the TAI list should be set to contain the new/updated area that has been determined by the network (e.g., by the AMF).

As described above, when the AMF determines that the disaster area for a PLMN has changed, and the AMF is serving a UE for disaster roaming service where the UE is associated with the PLMN in question (or optionally where the UE has previously indicated the identity of that PLMN in its registration with the network), then the AMF may determine and/or assign a new/updated TAI list for the UE, such that the new registration area (or the new TAI list) overlaps with the new/updated area of the disaster condition. The network (e.g., the AMF) may then send a Configuration Update Command message to the UE and include the new/updated TAI fist. This may be done when the UE is already in a 5GMM-CONNECTED mode,

If the UE is in an idle mode, the AMF or network may first page the UE to get it to 5GMM-CONNECTED mode. After the UE is in 5GMM-CONNECTED mode, then the AMF may behave as described above.

Alternatively, if the UE is in 5GMM-IDLE mode and the UE sends any initiate NAS message, then the AMF may perform as follows:
If the UE sends the NAS message (e.g. Registration Request) from a TAI (or from the TAI of the current cell) that is not part of the current RA of the UE, then the AMF may verify if the TAI from which the message is received (or the TAI of the cell from which the message is received) overlaps with (or corresponds to) a new/updated area of the disaster area. If yes, i.e., if the TAI overlaps with the new/updated area, then the AMF may accept the UE's registration and send a Registration Accept message and include the TAI list containing the TAI(s) that correspond to the new/updated disaster area.
If the UE sends the NAS message and the TAI of the current cell is part of the current RA of the UE, and if the AMF determines that the current TAI is no longer overlapping with a new/updated disaster area, then the AMF may reject the NAS message with an existing 5GMM cause value (e.g., #11 or #13) or a new 5GMM cause value. The AMF may send a Service Reject or Registration Reject based on the received NAS message.

In accordance with an embodiment of the disclosure a method is provided for determining which IE to send and how to send it.

Regarding the conditions and/or determination to send the PLMN identity by the UE, where the PLMN identity corresponds to the PLMN ID that has experienced disaster roaming (or the PLMN ID that the UE was registered with or wanted to register with, but has experienced disaster condition), the UE may perform any of the following actions:
If the UE has a valid 5G GUTI from a PLMN, where the PLMN is the same as the PLMN ID that has experienced a disaster roaming, and:
   If the UE has determined to send both the 5GS mobile identity IE and the Additional GUTI IE (e.g., based on the existing conditions in TS24.501, e.g., the UE was previously registered in EPS, etc.), then the UE verifies if the PLMN ID of the 5G GUTI in the Additional GUTI IE (or the native 5G GUTI) is the same as the PLMN ID in the 5GS mobility identity IE. If yes, the UE may take no further action. Alternatively, the UE may only send the 5GS mobile identity IE but not send the Additional 5G GUTI IE. Alternatively, the UE may include the value of the native 5G GUTI into the 5GS mobile identity IE (and may decide to send it with or without sending the Additional GUTI IE).
   If the UE intends to indicate the PLMN ID of a PLMN that has experienced disaster roaming and this PLMN ID corresponds to the PLMN part of a native 5G GUTI (which would have been sent in the Additional GUTI IE) and the UE also needs to send the 5GS mobile identity IE but the PLMN part of the value of the 5GS mobile identity IE is not the same as the PLMN ID that the UE wants to indicate as the PLMN with disaster roaming, then the UE may determine to set the value of the 5GS mobile identity IE as the native 5G GUTI (that would have been sent in the Additional GUTI IE) and may not send the Additional GUTI IE
   If the UE determines to send both the 5GS mobile identity IE and the Additional GUTI IE (e.g., based on the existing conditions in TS24.501, e.g., the UE was previously registered in EPS, etc.), and the PLMN ID that the UE wants to indicate as the PLMN with disaster condition part of one of these IEs but not both, the UE may send an additional indication to inform the network about which IE should be used by the network to determine the PLMN ID of the PLMN with disaster condition. This indication may be part of a new IE or may be part of an existing IE.
   If the UE determines the PLMN ID part in the 5GS mobile identity IE and the PLMN ID part of the Additional GUTI IE (e.g., based on the existing conditions in TS24.501, e.g., the UE was previously registered in EPS, etc.) are different (for example 5GS mobile identity IE is having PLMN part as PLMN-X and Additional GUTI is having PLMN part as PLMN-Y) then the UE shad include in the REGISTRATION REQUEST message the PLMN with disaster condition IE indicating the PLMN with disaster condition.

The UE may perform according to any of the above, in any order or combination, if the UE is registering for disaster roaming.

For the network behavior in determining the PLMN ID that is associated with the disaster condition, the network (e.g., the AMF) may operate as follows:
If the NAS message (e.g., a Registration Request) includes the Additional GUTI IE and the 5GS mobile identity IE:
   If both the PLMN component in both IEs is the same, then the AMF can use any of these IEs to determine the PLMN ID of the PLMN with disaster condition,
   If the PLMN component is different in these IEs, then the AMF may:
      Always use the contents of the Additional GUTI IE to determine the PLMN ID of the PLMN with disaster condition, or
      Always use the contents of the 5GS mobile identity IE to determine the PLMN ID of the PLMN with disaster condition, or
      If the NAS message contains an indication about which IE to use, then the AMF uses the indicated IE as the IE for determining the PLMN ID of the PLMN with disaster condition. As such the AMF will consider the contents of that IE and determine PLMN component of that IE as the PLMN ID of the PLMN with disaster condition.
      If the PLMN with disaster condition IE indicating the PLMN with disaster condition is received, the AMF uses the PLMN ID in the PLMN with disaster condition IE to determine the PLMN with disaster condition.

With regards to how to send the identity of the PLMN with disaster condition (which can be sent in any IE, e.g., the PLMN with disaster condition IE), the UE may operate as follows:
The UE may send this information only after the establishment of an NAS security is completed. As such, the UE may send this information as a protected information, e.g., as part of the Security Mode Complete message, either as a separate IE in the Security Mode Complete message, or as part of the Registration Request message that is included in the NAS message container IE.
   If the AMF receives a PLMN ID optionally from the UE (e.g., in any NAS message, e.g., the Security Mode Complete message or Registration Request message), where the PLMN ID identifies the PLMN with a disaster condition, then the AMF may verify if it can serve UEs that are associated with this PLMN or that have indicated this PLMN. If not, then the AMF may send an NAS reject message, e.g., Registration Reject message, and include an existing 5GMM cause value (e.g. #11, #13, etc.) or a new 5GMM cause value, As such, based on the received PLMN, the AMF may reject the request if the indicated/received PLMN does not correspond to any of the PLMNs for which the network can provided disaster roaming service.
In another alternative, e.g., for the purpose of indicating the PLMN ID in a faster manner, the UE may send the PLMN ID (e.g., the (which can be sent in any IE e.g. the PLMN with disaster condition IE) as a cleartext IE i.e, the UE may send this information in the clear without any NAS protection.
   The AMP may behave as described above when it determines that the PLMN ID does not correspond to any PLMN for which it provides disaster roaming service.

With regards to the UE sending the EPS NAS message container IE during a registration procedure for disaster roaming, the following steps may be followed.

If the UE is registering for disaster roaming, then the UE should not send the IE, even if other conditions for sending this IE are met. As such, the UE should check the following conditions for sending this E.

The UE operating in a single-registration mode shall include this information element as specified in subclause 5.5.1.3.2 of TS24.501, if the UE performs mobility from S1 mode to N1 mode in 5GMM-IDLE mode and the UE is not performing a registration procedure for disaster roaming service. (The content of this message container is the complete integrity protected TRACKING AREA UPDATE REQUEST message, using EPS security context.)

The UE performing initial registration shall include this information element if:
a) the UE:
   1) was previously registered in S1 mode before entering state EMM-DEREGISTERED; and
   2) has received an “interworking without N26 interface not supported” indication from the network; and
b) EPS security context and a valid 4G-GUTI are available, and
c) the UE is not registering for disaster roaming service
(The content of this message container is the complete integrity protected ATTACH REQUEST message, using EPS security context.)

The UE not registering for disaster roaming service can indicate that the UE does not request disaster roaming service in the 5GS registration type IE (regardless if the registration is initial registration for disaster roaming, or disaster roaming registration, etc., or any other value),

As such, the UE may now consider the type of registration, or the type of service that it is registering for, in order to determine whether the EPS NAS message container IE may be included in the NAS message (e.g., a Registration Request message) or not. If the UE is registering for disaster roaming service, then the UE should not include this IE even if the other existing conditions for including this IE are met. If the UE is not registering for disaster roaming service, then the UE can include the IE if the other conditions for including the IE are met.

Alternatively, if the AMF receives a Registration Request in which the AMF determines that the UE is registering for disaster roaming (e.g., based on the value of the 5GS registration type IE), then the AMF may ignore or discard the contents of the EPS NAS message container IE, if the IE is included in the message. Otherwise, if the AMF receives the EPS NAS message container IE in an NAS message and the UE is not registering for disaster roaming, then the AMF can process the IE contents as currently described in TS 24.501.

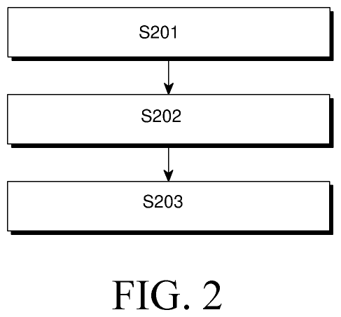

FIG. 2 is a flowchart illustrating a method according to an embodiment.

Referring to FIG. 2, in step S201, a UE is disaster roaming in a second telecommunications network due to a disaster condition affecting an area of a first telecommunication network.

In step S202, the second network determines that the area has changed, and in step S203, sends details of the changed area to the UE. The changed area may be defined in terms of an RA including one or more TAIs.

The above-described embodiments of the disclosure provide various solutions to the problems identified earlier in this application. As such, the uncertainty and delays experienced in conventional disaster roaming service can be avoided or at least minimized.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a field programmable gate array (FPGA) or an application specific integrated circuit (ASIC), which performs certain tasks or provides the associated functionality.

In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and any equivalents thereof.

What is claimed is:

1. A method performed by a second telecommunication network due to a disaster condition affecting an area of a first telecommunication network, the method comprising:
determining that the area has changed; and
sending updated details to a user equipment (UE),
wherein the updated details relate to the changed area affected by the disaster condition, and
wherein the UE is disaster roaming in the second telecommunication network.

2. The method of claim 1, wherein the area and the changed area are defined in terms of a registration area (RA).

3. The method of claim 2, wherein the RA includes one or more tracking area identities (TAIs).

4. The method of claim 1, wherein the changed area is entirely separate from the area, entirely contained within the area, or overlapping with the area.

5. The method of claim 1, further comprising determining, by an access and mobility management function (AMF) of the second telecommunication network, the changed area.

6. The method of claim 1, wherein the updated details are sent to the UE via a non-access stratum (NAS) message.

7. The method of claim 6, wherein the NAS message includes a configuration update command message including one or more TAIs that correspond to the changed area.

8. The method of claim 1, further comprising, in case that the UE is not in a connected state, paging the UE to get it into the connected state.

9. The method of claim 1, further comprising:
receiving a non-access stratum (NAS) message from the UE;
determining that the UE is not in an area impacted by the disaster condition; and
rejecting the NAS message from the UE, based on determining that the UE is not in the area impacted by the disaster condition.

10. The method of claim 9, further comprising rejecting the NAS message due to the change in the area,
wherein the area from which the UE sent the NAS message was previously an area in which a disaster roaming service was provided.

11. The method of claim 1, wherein rejecting the NAS message from the UE comprises an access and mobility management function (AMF) of the second telecommunication network rejecting NAS message with a 5^{th} generation mobility management (5GMM) cause code #11 or #13.

12. A method performed by a user equipment (UE), the method comprising:
indicating, in cleartext, to a first telecommunication network offering disaster roaming, an identity of a second telecommunication network that has experienced a disaster condition.

13. The method of claim 12, wherein the second telecommunication network is a telecommunication network with which the UE is coming from or which it intended to register with.

14. An apparatus in a second telecommunications network, the apparatus comprising;
a transceiver: and
a processor configured to:
determine, during a disaster condition affecting an area of a first telecommunication network, that the area has changed, and
send, via the transceiver, updated details to a user equipment (UE),
wherein the updated details relate to the changed area affected by the disaster condition, and
wherein the UE is disaster roaming in the second telecommunication network.

15. The apparatus of claim 14, wherein the area and the changed area are defined in terms of a registration area (RA), and
wherein the RA includes one or more tracking area identities (TAIs).

16. The apparatus of claim 14, wherein the changed area is entirely separate from the area, entirely contained within the area, or overlapping with the area.

17. The apparatus of claim 14, wherein the processor is further configured to determine, by an access and mobility management function (AMF) of the second telecommunication network, the changed area.

18. The apparatus of claim 14, wherein the updated details are sent to the UE via a non-access stratum (NAS) message.

19. A user equipment (UE), comprising:
a transceiver; and
a processor configured to send, via the transceiver, in cleartext, to a first telecommunication network offering disaster roaming, an identity of a second telecommunication network that has experienced a disaster condition.

20. The UE of claim 19, wherein the second telecommunication network is a telecommunication network with which the UE is coming from or which it intended to register with.
